(19) United States
(12) Patent Application Publication
(10) Pub. No.: US 2020/0318363 A1
(43) Pub. Date: Oct. 8, 2020

(54) ARTIFICIAL FLOOR

(71) Applicant: MEGA MASTER TECHNOLOGY CO., LTD., New Taipei City (TW)

(72) Inventor: Chun-Yung YU, New Taipei City (TW)

(73) Assignee: MEGA MASTER TECHNOLOGY CO., LTD., New Taipei City (TW)

(21) Appl. No.: 16/838,819

(22) Filed: Apr. 2, 2020

(30) Foreign Application Priority Data
Apr. 3, 2019 (TW) 108112050

(51) Int. Cl. E04F 15/10; B32B 7/022; B32B 7/12; B32B 5/18; B32B 5/16; B32B 5/30; E04F 15/20

(52) U.S. Cl. CPC E04F 15/107; B32B 7/022; B32B 7/12; B32B 5/18; E04F 15/02038; B32B 5/30; E04F 15/206; B32B 2419/04; B32B 2307/536; B32B 5/16

(57) ABSTRACT

The present disclosure provides an artificial floor. The artificial floor comprises a plate body with a pad portion on a surface thereof. The pad portion contacts with a subfloor when the plate body is disposed on the subfloor. The plate body could be various kinds of the simulated floor such as linen, wood, or stone. The simulated floor is poor in wear resistance. The vibration or shaking during transportation may cause wearing between the simulated floors so as to damage the surfaces of the simulated floors. The subfloor may have an uneven surface, which may affect the surface flatness of the plate body disposed on the subfloor. Therefore, the pad portion of the plate body could be used as a cushion for the transportation process to protect the collision and wearing between the plate bodies. The pad portion could also be deformed locally to close the surface of the subfloor.

### CROSS REFERENCE TO RELATED APPLICATION

This application claims the priority benefit of Taiwanese Patent Application Serial Number 108112050, filed on Apr. 3, 2019, the full disclosure of which is incorporated herein by reference.

### BACKGROUND

### Technical Field

The present disclosure relates to the technical field of artificial floor, and more particularly to an artificial floor comprising a plate body with a pad portion.

### Related Art

At present, most existing floors are plastic floors (PVC floors). The advantages of this kind of plastic floor are cheap, simple to install and easy to maintain. The plastic flooring comes in many styles, such as imitation wood, stone or linen. In order to achieve the touch and anti-slip effects of the imitation wood floor, imitation stone floor or imitation linen floor, manufacturers usually emboss on the surface of the upper floor or add materials (such as stone powder or wood powder) in the upper floor different from that of the lower floor followed by combining the upper and lower floors. However, the performance of the wear resistance of the above plastic floor materials is poor. During the transportation of the floor, the vehicle will inevitably be subject to up and down vibration or left and right shaking, which easily causes the surfaces between the floors to be worn and torn. Due to the thin thickness of the plastic floor, the surface of the plastic floor tends to be uneven when it is disposed on uneven ground.

Moreover, connecting members are further provided on the peripheral of the upper floor to splice other upper floors as connecting tenon. The connecting member is thinner than the upper floor, so it is more fragile than other parts of the upper floor. The connecting members are easily broken or damaged when the upper floor comprising connecting members is disposed on uneven ground (the lower floor).

### SUMMARY

The issues that the embodiments of the present disclosure tend to solve could not be settled by prior arts. At present, the vibration and shaking would cause the surfaces between the floors to be worn and torn during transportation as the performance of the wear resistance of the plastic floor is poor. Furthermore, the surface of the plastic floor tends to be uneven when it is disposed on uneven ground due to the thin thickness of the floor.

An artificial floor is provided to solve the issue above, which comprises a plate body having a pad portion on one surface thereof. The pad portion is in contact with the subfloor when the plate body is disposed on a subfloor.

According to one embodiment of the present disclosure, the plate body further comprises a surface portion disposed on the pad portion. The surface portion comprises a surface material.

According to one embodiment of the present disclosure, the surface material could be wood powder, stone powder or plant fibers.

According to one embodiment of the present disclosure, the surface portion is designed in the style of wood, stone, carpet or metal grain.

According to one embodiment of the present disclosure, the hardness of the surface portion is greater than the hardness of the pad portion. The hardness difference between the surface portion and the pad portion ranges from 10 to 75 degrees or 5 to 60 degrees (Shore A) as measured by a spring type ASKER-C tester specified in JIS-S6050 and SRIS-0101 hardness standards. The hardness of the pad portion is adjusted based on the hardness of the surface portion. The greater the hardness of the surface portion, the greater the hardness of the pad portion. The hardness of the pad portion is smaller than or equal to the hardness of the surface portion.

According to one embodiment of the present disclosure, the surface portion is bonded to the pad portion by heating or adhesive.

According to one embodiment of the present disclosure, the pad portion comprises a plurality of sealed air holes.

According to one embodiment of the present disclosure, the thickness of the pad portion ranges from 0.01 mm to 15 mm.

According to one embodiment of the present disclosure, the pad portion has undergone multiple electro-crosslink foaming.

According to one embodiment of the present disclosure, the peripheral of the plate body further comprises at least one connecting member.

In the embodiments of the present disclosure, the pad portion of the artificial floor is used as a cushion for the transportation process to reduce the collision and wearing between the floor plates. The pad portion of the artificial floor in different thicknesses and hardness can be correspondingly used with the surface portion of the artificial floor having surface materials in different hardness. The plate body is composed of multiple independent plates, which can independently deform in correspond to the unevenness of the subfloor so that the pad portion of the plate body can be individually deformed to adapt to the ground changes of the subfloor. In this way, the plate body can be closely adhered to the surface of the subfloor, making the surface of the plate body perfectly flat.

It should be understood, however, that this summary may not contain all aspects and embodiments of the present invention, that this summary is not meant to be limiting or restrictive in any manner, and that the invention as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is a schematic perspective view of an artificial floor of the present disclosure;

FIG. 2 is a schematic side view of an artificial floor of the present disclosure;

FIG. 3 is a schematic diagram of the side assembly of an artificial floor of the present disclosure;

FIG. 4 is a schematic diagram of stacking of an artificial floor of the present disclosure;

FIG. 5 is another schematic diagram of stacking of an artificial floor of the present disclosure;

FIG. 6 is a schematic diagram of assembling of an artificial floor of the present disclosure; and

FIG. 7 is another schematic diagram of assembling of an artificial floor of the present disclosure.

### DETAILED DESCRIPTION OF THE EMBODIMENTS

The present invention will now be described more fully hereinafter with reference to the accompanying drawings, in which exemplary embodiments of the invention are shown. This present invention may, however, be embodied in many different forms and should not be construed as limited to the embodiments set forth herein. Rather, these embodiments are provided so that this present invention will be thorough and complete, and will fully convey the scope of the present invention to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the invention. This description is made for the purpose of illustration of the general principles of the invention and should not be taken in a limiting sense. The scope of the invention is best determined by reference to the appended claims.

Moreover, the terms “include”, “contain”, and any variation thereof are intended to cover a non-exclusive inclusion. Therefore, a process, method, object, or device that comprises a series of elements not only include these elements, but also comprises other elements not specified expressly, or may include inherent elements of the process, method, object, or device. If no more limitations are made, an element limited by “include a/an . . . ” does not exclude other same elements existing in the process, the method, the article, or the device which comprises the element.

In the following embodiment, the same reference numerals are used to refer to the same or similar elements throughout the invention.

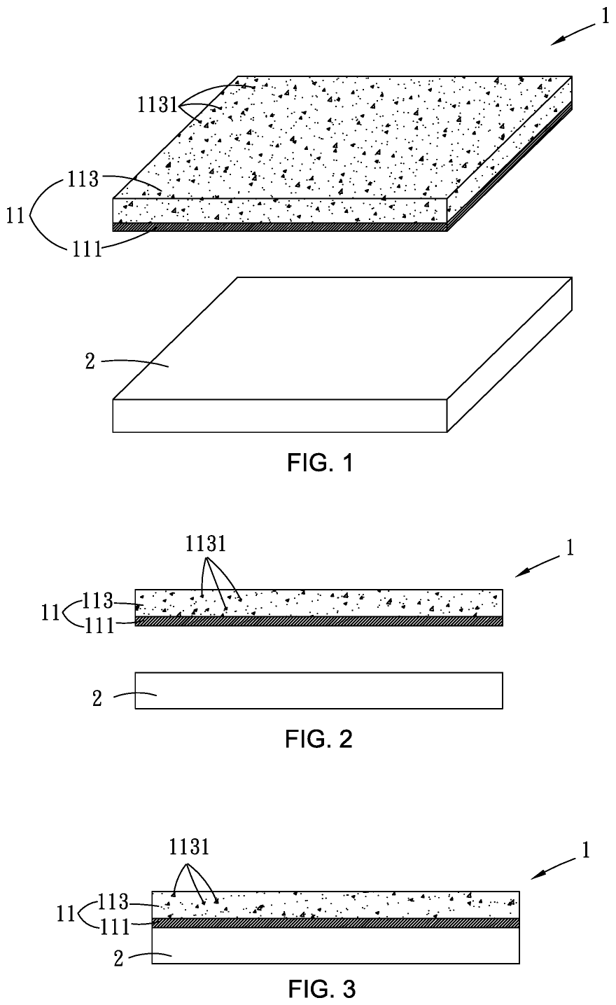

FIG. 1 and FIG. 2 are a schematic perspective view and a schematic side view of an artificial floor of the present disclosure. As shown in the figures, the present embodiment provides a plate body 1 comprising a pad portion 11 disposed on a subfloor 2. The subfloor 2 may be the ground or floor surface. The plate body 11 comes up with various styles, such as various artificial floors with designing in imitation linen floor, 0wood imitation floor (WPC) or stone imitation floor (SPC). The desired floor style could be chosen according to requirements. The plate body 11 and the subfloor 2 can be adhesively bonded, or the plate bodies 11 can be directly disposed on the subfloor 2 after being spliced to each other.

Furthermore, one surface of the plate body 11 comprises a pad portion 111. When the plate body 11 is disposed on the subfloor 2, the surface of the plate body 11 with the pad portion 111 is in contact with the subfloor 2. The pad portion 111 of the plate body 11 comprises a plurality of closed-cell foams, wherein the pad portion 111 has been subjected to multiple times of electro-crosslink foaming. There are many ways to irradiate the electron beam. Different electron beam irradiations can be performed through the control of irradiation dose and irradiation depth to control the irradiated pad portion 111 to generate different ways of electro-crosslink. The process of electro-crosslink with electron beam irradiation is simple and fast, which eliminates the harmful organic chemicals. It also reduces the manufacturing cost of adding a cross-linking agent, and can shorten the test time of crosslinking reaction conditions of pad portion 111. The foaming with electron beam improves the physical properties of the pad portion 111, providing an excellent foaming uniformity for the pad portion 111.

The other surface of the plate body 11 comprises a surface portion 113 provided on the pad portion 111. The surface portion 113 and pad portion 111 are bonded by heating or adhesive. The heat-bonding methods comprises infrared heating or flame heating. Taking the flame heat-bonding method as an example, the pad portion 111 and the surface portion 113 are burned to bond to each other through a high-temperature flame, so there is no issue of rubber residues. In the flame bonding process, the combustion of the plurality of closed air holes of the pad portion 111 causes the air consumption in the closed air holes (that is, the effect similar to the air extraction). These closed air holes would be in a vacuum-like state, thereby reducing heat convection and heat conduction as well as reducing the vibration transmission of sound through the medium of air to achieve thermal and sound insulation.

Moreover, the surface portion 113 of the plate body 11 comprises a surface material 1131. The plate body 11 is formed after the process of heating and pressurizing to the mixed material made of the surface material 1131, plastic material and other material. The surface material 1131 can be wood powder, stone powder or plant fibers. The surface portion 113 could be designed in the style of wood, stone, carpet, metal grain or other styles. The above designs would be selected based on user requirements and would not be limited herein.

FIG. 3 is a schematic diagram of the side assembly of an artificial floor of the present disclosure. In this embodiment, the wear resistance of the surface potion 113 of the plate body 11 is poor. The hardness of the surface portion 113 is greater than the hardness of the pad portion 111. The hardness difference between the surface portion 113 and the pad portion 111 ranges from 10 to 75 degrees or 5 to 60 degrees (Shore A) as measured by a spring type ASKER-C tester specified in JIS-56050 and SRIS-0101 hardness standards. The hardness of the pad portion 111 is adjusted based on the hardness of the surface portion 113. The greater the hardness of the surface portion 113, the greater the hardness of the pad portion 111. The hardness of the pad portion 111 is smaller than or equal to the hardness of the surface portion 113. The pad portion 111 is rubbery and can be used as a member for protecting and supporting the surface portion 113.

The thickness of the pad portion ranges from 0.01 mm to 15 mm The thickness of the pad portion 111 can be adjusted according to the requirements of the construction environment (such as the hardness of the surface portion 113). In this way, the pad portion 111 can support and cushion the surface portion 113.

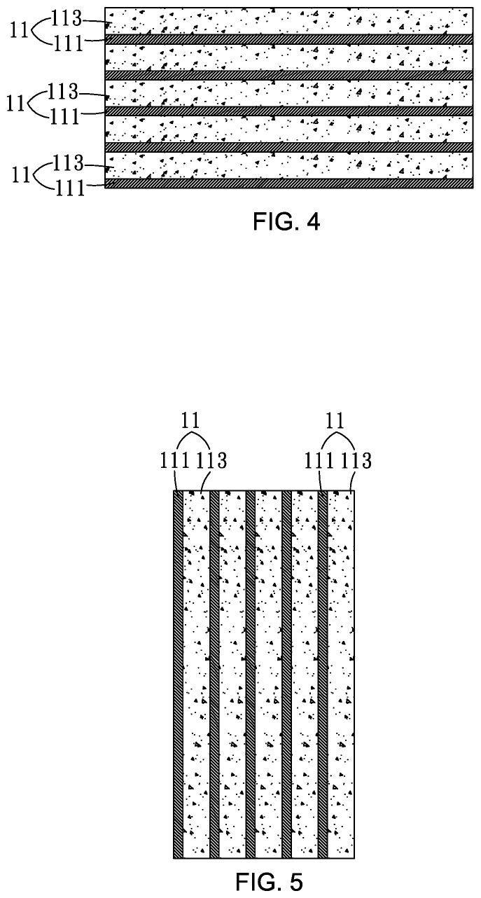

FIG. 4 and FIG. 5 are a schematic diagrams of stacking of an artificial floor of the present disclosure. In this embodiment, the plate body 11 is transported in a stacked state. The stacking could be the top and bottom stacking or left and right stacking. The grains of the surface portion 113 of the plate body 11 is prone to be scratched or damaged due to the wearing of the plate body 11 by the up-down vibration or left-right shaking during the transportation of the stacked plate bodies 11. Therefore, in this embodiment, when the plate body 11 is stacked on another plate body 11, the pad portion 111 of the plate body 11 contacts the surface portion 113 of the other plate body 11. The pad portion 111 can cushion the vibration or shaking of the surface portion 113 contacting the plate body 11 to protect the surface of the plate body 11.

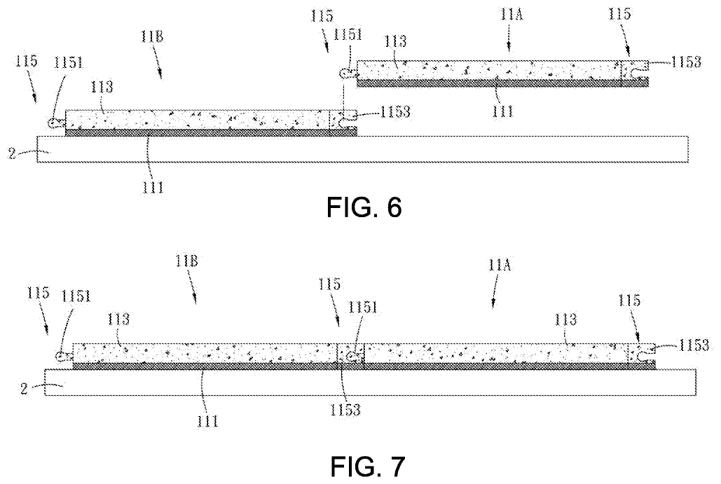

FIG. 6 and FIG. 7 are schematic diagrams of assembling of an artificial floor of the present disclosure. In this embodiment, the peripheral of the plate body 11 further comprises a plurality of connecting members 115 comprising a first connecting member 1151 and a second connecting member 1153. The first connecting member 1151 is disposed on one side of the plate body 11. The second connecting member 1153 is disposed on the other side of the plate body 11. In this embodiment, the first connecting member 1151 of the plate body 11A is connected to the second connecting member 1153 of the other plate body 11B when the plate body 11A is spliced with another plate body 11B. The first connecting member 1151 is a bump member. The second connecting member 1153 is a groove member. To engage the first connecting member 1151 with the second connecting member 1153 in order to securely engage the plate body 11A with the other plate body 11B.

Therefore, the first connecting member 1151 is disposed on one side of the surface portion 113 and is far from the pad portion 111. The second connecting member 1153 is disposed on one side of the surface portion 113 and is close to the pad portion 111. The pad portion 111 is further extended to the bottom of the second connecting member 1153. In this way, the pad portion 111 can be a supporting member disposed below the second connecting member 1153, thereby protecting the second connecting member 1153. The second connecting member 1153 and the pad portion 111 enhance the supporting force of the second connecting member 1153 connected to one side of the plate body 11, making the second connecting member 1153 to be hardly broken by external forces during transportation. When disposing a plurality of plate bodies 11 on the subfloor 2, the uneven of the subfloor 2 would affect the second connecting piece 1153 of the subfloor 2 and break the second connecting piece 1153 during splicing and disposing the plate bodies 11 if the subfloor 2 is uneven. Thus, the second connecting member 1153 in this embodiment also takes the pad portion 111 as a protection member to support and cushion, reducing the influence of the uneven to the second connecting member 1153.

Moreover, in most of the conventional artificial flooring methods, a large area of pad layer is disposed at first followed by splicing floor plates into floor surface on above of the pad layer. The entire pad layer would deform with the uneven bottom layer floor when a large area of pad layer is disposed on the uneven bottom layer floor. This would enlarge the gap between floor plates of the floor surface and would hardly fit floor plates onto the pad layer causing floor plates coming off easily under such circumstances of uneven floors. Thus, in this embodiment, each plate body 11 is an independent individual directly disposed on the subfloor 2 when splicing plate bodies 11 of the artificial floor 1. The bottom surface of the plate body 11 is provided with a pad portion 111, which causes the pad portion 111 of the plate body 11 to independently deform with the unevenness of the subfloor 2. Furthermore, the flexibility of the pad portion 111 of the plate body 11 can be enhanced to minimize the unevenness of the plate body 11 since each plate body 11 is an independent individual and the gaps between plate bodies 11 provide spaces for each pad portion 111 to be adjusted and deformed individually. In this way, the plate body 11 can better match the unevenness of the subfloor 2, and the installation of the conventional floors can be improved without disposing the pad layer before the floor plates.

In summary, the present disclosure provides an artificial floor comprising a plate body comprising a pad portion on the bottom of the plate body. The pad portion is disposed on the subfloor. The plate body could be a variety of artificial floors such as imitation linen, wood or stone. The vibration or shaking during transportation could cause collision or wearing between floors plates, which damages the surface of the floor since the poor wearing resistance of the above various imitation floors. In addition, the subfloor may also be an uneven surface, which will affect the flatness of the plate bodies. Therefore, the pad portion of the plate body can be used as cushion for the transportation process to protect the plate bodies from collision and wearing, and can also prevent the connecting member from breaking. The pad portion can also be deformed locally to closely adhere to the surface of the subfloor.

It is to be understood that the term “comprises”, “comprising”, or any other variants thereof, is intended to encompass a non-exclusive inclusion, such that a process, method, article, or device of a series of elements not only include those elements but also comprises other elements that are not explicitly listed, or elements that are inherent to such a process, method, article, or device. An element defined by the phrase “comprising a . . . ” does not exclude the presence of the same element in the process, method, article, or device that comprises the element.

Although the present invention has been explained in relation to its preferred embodiment, it does not intend to limit the present invention. It will be apparent to those skilled in the art having regard to this present invention that other modifications of the exemplary embodiments beyond those embodiments specifically described here may be made without departing from the spirit of the invention. Accordingly, such modifications are considered within the scope of the invention as limited solely by the appended claims.

What is claimed is:

1. An artificial floor, comprising:
a plate body comprising a pad portion on a surface thereof; the pad portion is in contact with a subfloor when the plate body is disposed on the subfloor.

2. The artificial floor according to claim 1, wherein the other surface of the plate body comprises a surface portion disposed on the pad portion; the surface portion comprises a surface material.

3. The artificial floor according to claim 2, wherein the surface material is wood powder, stone powder or plant fibers.

4. The artificial floor according to claim 2, wherein the surface portion is designed in the style of wood, stone, carpet or metal grain.

5. The artificial floor according to claim 2, wherein the hardness of the surface portion is greater than the hardness of the pad portion; the hardness difference between the surface portion and the pad portion ranges from 10 to 75 degrees or 5 to 60 degrees (Shore A) as measured by a spring type ASKER-C tester specified in JIS-56050 and SRIS-0101 hardness standards; the hardness of the pad portion is adjusted based on the hardness of the surface portion; the greater the hardness of the surface portion, the greater the hardness of the pad portion; the hardness of the pad portion is smaller than or equal to the hardness of the surface portion.

6. The artificial floor according to claim 2, wherein the surface portion is bonded to the pad portion by heating or adhesive.

7. The artificial floor according to claim 1, wherein the pad portion comprises a plurality of sealed air holes.

8. The artificial floor according to claim 1, wherein the thickness of the pad portion ranges from 0.01 mm to 15 mm.

9. The artificial floor according to claim 1, wherein the pad portion has undergone multiple electro-crosslink foaming.

10. The artificial floor according to claim 1, wherein the peripheral of the plate body further comprises at least one connecting member.
